(19) United States
(12) Patent Application Publication
(10) Pub. No.: US 2016/0334081 A1
(43) Pub. Date: Nov. 17, 2016

(54) Coupling Structure of Lamp Holder Housing

(71) Applicant: Rich Brand Industries limited, Dongguan City (CN)

(72) Inventor: Te-Shui Peng, Taoyuan City (TW)

(21) Appl. No.: 14/713,164

(22) Filed: May 15, 2015

(51) Int. Cl. F21V 15/01

(52) U.S. Cl. CPC F21V 15/01

(57) ABSTRACT

A coupling structure of a lampholder housing includes an outer sleeve and a top cover. The outer sleeve includes at least one square slot and at least one L-shaped notch formed at an outer wall proximate to the top edge of the outer sleeve. The top cover includes a first transverse flip plate disposed at an inner periphery proximate to the bottom of the top cover and corresponsive to the square slot and a second transverse flip plate corresponsive to the L-shaped notch. When the top cover is covered onto the outer sleeve, the first transverse flip plate pushes a wall of the outer sleeve to be pressed into the square slot while the second transverse flip plate is being entered along the L-shaped notch, so that the top cover and the outer sleeve are connected securely with each other.

### BACKGROUND OF THE INVENTION

1. Field of the Invention

The present invention relates to a coupling structure of a lampholder housing, and more particularly to the coupling structure of a lampholder housing with a secured coupling effect to prevent the lampholder housing from being loosened or separated, so as to prevent accidental electric shock.

2. Description of the Related Art

Lampholder is a common electric appliance used in our daily life. With reference to FIGS. 1 and 2 for a conventional lampholder 10 provided for screwing and connecting a light bulb and conducting electric power to light up the light bulb, the conventional lampholder 10 comprises a main body 11, an outer sleeve 12 and a top cover 13, wherein a bulb screwing section 111 is disposed at a lower section of the main body 11, and a power cord 112 is connected to an upper end surface of the main body 11; the outer sleeve 12 is a cylindrical body with opened top and bottom and sheathed on the exterior of the main body 11 and the bulb screwing section 111. If the outer sleeve 12 is made of metal, then an insulating cylinder 121 is installed in the outer sleeve 12, so that an insulating effect exists among the outer sleeve 12, the main body 11 and the bulb screwing section 111. The top cover 13 is covered onto the top of the outer sleeve 12, and the top cover 13 and the outer sleeve 12 jointly form the “lampholder housing” provided for covering the main body 11 and the bulb screwing section 111, and just exposing a lower opening of the bulb screwing section 111 to the outside to allow a light bulb to be screwed to the bulb screwing section 111. As to the types of switches, lampholder 10 is mainly divided into a switchless lampholder (as shown in FIGS. 1 and 2) which is used together with a cable, a knob type lampholder (as shown in FIG. 3), a push-pull switch type lampholder (as shown in FIG. 4) and a zipper type lampholder (as shown in FIG. 5), and different types of switches of the lampholder 10 are used for turning on or off the light bulb.

In the aforementioned conventional lampholder 10, the outer sleeve 12 and the top cover 13 jointly form the “lampholder housing” used for covering the main body 11 and the bulb screwing section 111 to prevent a direct contact with users, wherein the outer sleeve 12 includes at least one flip block 122 slightly protruded from an outer wall proximate to the top of the outer sleeve 12, and the top cover 13 includes at least one flip plate 132 inwardly and concavely formed at an inner periphery of the bottom of the top cover 13, so that when the top cover 13 is covered onto the top of the outer sleeve 12, and a slight force is applied to press and descend the top cover 13, the flip plate 132 of the top cover 13 and the flip block 122 of the outer sleeve 12 abut against each other to provide a latching effect, so as to achieve a connecting effect between the top cover 13 and the outer sleeve 12.

Although the latching effect between the flip plate 132 and the flip block 122 abutting against each other achieve a preliminary connecting effect between the top cover 13 and the outer sleeve 12, there is still a safety issue, since the flip plate 132 and the flip block 122 are not connected securely. If an external force is encountered, the flip plate 132 and the flip block 122 may be separated easily. During the process of using the lampholder 10, it is inevitable to encounter external forces (such as the external force produced by the frequent operations of the switch, and the external force produced by the circulation of current), and thus the top cover 13 and the outer sleeve 12 may be loosened or separated, and when the power cord 112 is exposed to the outside or the electrically conducted bulb screwing section 111 is touched, the accident of electric shock may occur, and improvements for overcoming such safety concern is urgently needed.

### SUMMARY OF THE INVENTION

Therefore, it is a primary objective of the present invention to provide a coupling structure of a lampholder housing with a secured coupling effect to prevent the lampholder housing from being loosened or separated, so as to prevent accidental electric shock.

To achieve the aforementioned object, the present invention provides a coupling structure of a lampholder housing comprising an outer sleeve and a top cover, wherein the outer sleeve includes at least one square slot and at least one L-shaped notch formed on an outer wall proximate to the top edge of the outer sleeve, and the L-shaped notch includes a longitudinal groove penetrating downwardly from the top edge to the bottom and deep into a distance and then making a right-angle turn to form a transverse chute, and an end of the longitudinal groove extending upward to form a latch tail groove, and the top cover includes at least one first transverse flip plate corresponsive to the square slot and at least one second transverse flip plate corresponsive to the L-shaped notch formed at the inner periphery proximate to the bottom of the top cover, such that when the top cover is covered onto the outer sleeve, the first transverse flip plate of the top cover pushes a wall of the outer sleeve to move and press into the square slot, while the second transverse flip plate of the top cover is being inserted downwardly into the longitudinal groove of the L-shaped notch of the outer sleeve, and then moved transversely along the transverse chute, and remained in the latch tail groove provided that there is no external force exerted onto the second transverse flip plate, so that the top cover and the outer sleeve are coupled securely.

### BRIEF DESCRIPTION OF THE DRAWINGS

FIG. 1 is an exploded view of a first conventional lampholder;

FIG. 2 is a cross-sectional view of the first conventional lampholder;

FIG. 3 is a cross-sectional view of a second conventional lampholder;

FIG. 4 is a cross-sectional view of a third conventional lampholder;

FIG. 5 is a cross-sectional view of a fourth conventional lampholder;

FIG. 6 is an exploded view of a lampholder housing of a preferred embodiment of the present invention;

FIG. 7 is a cross-sectional view of a lampholder housing of a preferred embodiment of the present invention; and

FIGS. 8-10 are schematic views showing the continuous motions of coupling a lampholder housing in accordance with a preferred embodiment of the present invention.

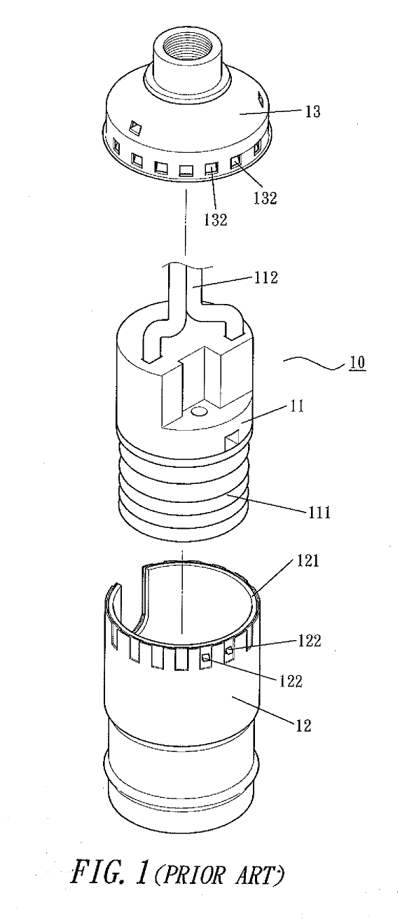

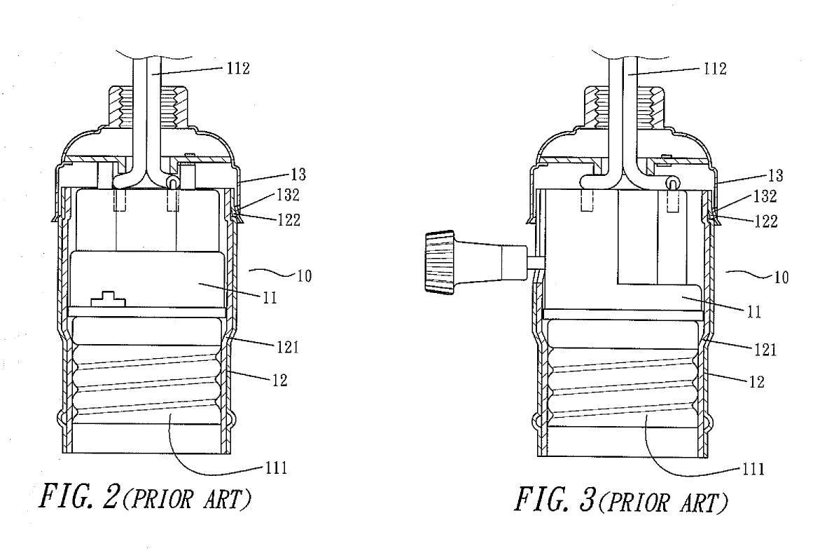

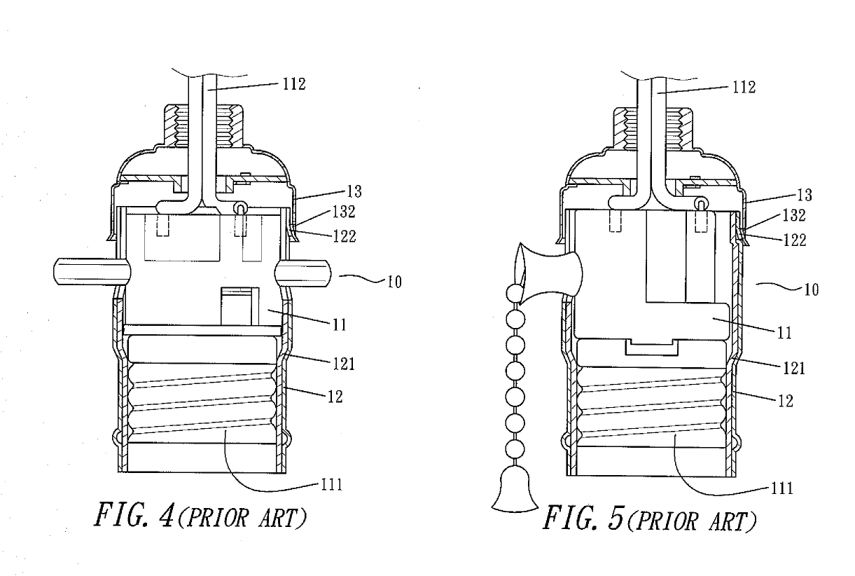

### DETAILED DESCRIPTION OF THE PREFERRED EMBODIMENTS

The technical characteristics, contents, advantages and effects of the present invention will be apparent with the detailed description of a preferred embodiment accompanied with related drawings as follows.

In accordance with a preferred embodiment of the present invention, a lampholder housing 2, regardless of its switch type, is provided for covering a main body and a bulb screwing section of a lampholder. Since the main body and the bulb screwing section are prior arts, they are not be illustrated in the drawings or described in details here.

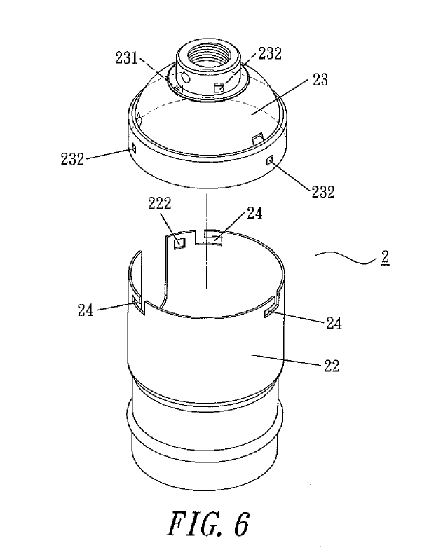

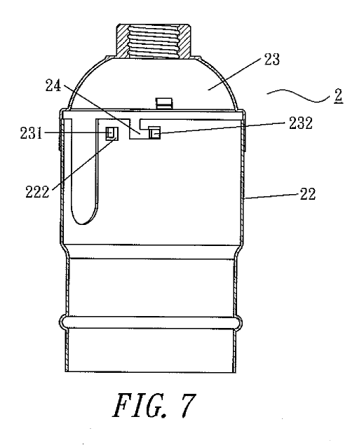

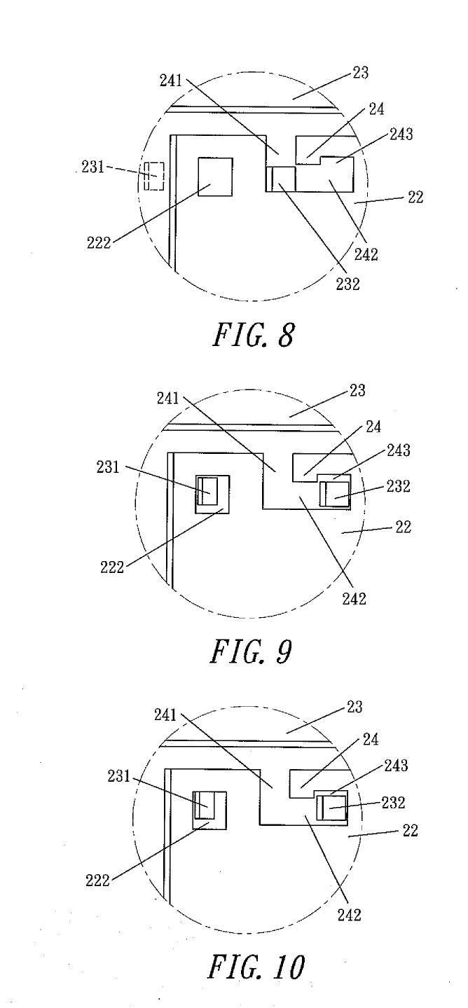

With reference to FIGS. 6 and 7 of the structure of the lampholder housing 2 of a preferred embodiment of the present invention, the lampholder housing 2 comprises an outer sleeve 22 and a top cover 23, wherein the outer sleeve 22 is a cylindrical body with opened top and bottom, and the outer sleeve 22 includes at least one square slot 222 formed on an outer wall proximate to the top of the outer sleeve 22 and at least one L-shaped notch 24, and the number of the square slots 222 is not necessary equal to the number of the L-shaped notches 24. In this preferred embodiment (as shown in FIG. 6), there is only one square slot 222, but there are three L-shaped notches 24. In FIG. 8, the L-shaped notch 24 includes a longitudinal groove 241 penetrating from the top edge to the bottom downwardly deep into and then turning at a right angle to form a transverse chute 242, and an end of the longitudinal groove 241 is upwardly extended to form a latch tail groove 243. The top cover 23 includes at least one first transverse flip plate 231 and at least one second transverse flip plate 232 formed at an inner periphery proximate to the bottom of the top cover 23, and the number of the first transverse flip plates 231 is equal to the number of the square slots 222, and the number of the second transverse flip plates 232 is equal to the number of the L-shaped notches 24. Due to the selection made by the design, the square slot 222 has a width and a height slightly greater than those of the first transverse flip plate 231, and both of the longitudinal groove 241 and the latch tail groove 243 have a width slightly greater than that of the second transverse flip plate 232, and the transverse chute 242 has a height slightly greater than that of the second transverse flip plate 232.

When the top cover 23 is covered onto the outer sleeve 22 during the assembling process, it is necessary to precisely align each second transverse flip plate 232 of the top cover 23 with the longitudinal groove 241 of each respective L-shaped notch 24 of the outer sleeve 22. Now, the first transverse flip plate 231 of the top cover 23 is not aligned precisely with the square slot 222. In FIG. 8, each second transverse flip plate 232 of the top cover 23 is pressed and installed into the longitudinal groove 241 of each respective L-shaped notch 24 until reaching the bottom of the groove. In the same process, the first transverse flip plate 231 of the top cover 23 pushes a wall of the outer sleeve 22 to descend altogether (wherein the outer sleeve 22 and the top cover 23 are made of a material capable of restoring its original shape after being pressed and deformed slightly), until reaching a position that is aligned precisely and transversely with the square slot 222.

In FIG. 9, the top cover 23 is pressed and rotated with respect to the outer sleeve 22, so that each second transverse flip plate 232 of the top cover 23 slides transversely in the transverse chute 242 of each respective L-shaped notch 24 until reaching the end of the groove. In the same process, the top cover 23 of the first transverse flip plate 231 pushes a wall of the outer sleeve 22 to move altogether transversely, and finally enter the corresponsive square slot 222, so as to achieve the coupling effect of the transverse latching.

In FIG. 10, neither the top cover 23 nor the outer sleeve 22 is pressed (or exerted by an external force) after being released, so that the elasticity of the material drives each second transverse flip plate 232 of the top cover 23 to move upward to abut the corresponsive latch tail groove 243. In the same process, the first transverse flip plate 231 of the top cover 23 moves accordingly in the corresponsive square slot 222 (since the height of the square slot 222 is sufficient for the movement of the first transverse flip plate 231). Now, the first transverse flip plate 231 remains to be latched and coupled to the first position transversely, while each second transverse flip plate 232 is latched and coupled to the second position transversely in each respective latch tail groove 243. Therefore, the top cover 23 and the outer sleeve 22 are coupled securely with each other since the two are transversely latched. The top cover 23 and the outer sleeve 22 will not be loosened or separated easily even if an external force is encountered, so as to prevent accidental electric shocks.

When a user needs to separate the disconnect the top cover 23 from the outer sleeve 22, the user has to press the top cover 23 and the outer sleeve 22 by hands, so that the second transverse flip plate 232 of the top cover 23 descends and moves away from the latch tail groove 243, and then turns in an opposite direction to slide each second transverse flip plate 232 of the top cover 23 in the transverse chute 242 until returning to the bottom of the longitudinal groove 241, and the first transverse flip plate 231 of the top cover 23 is moved transversely at the same time to push a wall of the outer sleeve 22 to release the latch with the square slot 222. Finally, the top cover 23 is lifted and removed, so that the second transverse flip plate 232 retracts upwardly from the outer sleeve 22 along the longitudinal groove 241, and the first transverse flip plate 231 also moves upwardly and retracts from the outer sleeve 22, so that the top cover 23 and the outer sleeve 22 are separately completely from each other.

In summation of the description above, the present invention is characterized in that the outer sleeve 22 includes at least one square slot 222 and at least one L-shaped notch 24 formed on an outer wall proximate to the top edge of the outer sleeve 22, and the L-shaped notch 24 includes a longitudinal groove 241 penetrating from the top edge downwardly deep into a distance and then turning at a right angle to form a transverse chute 242, and an end of the longitudinal groove 241 is extended upwardly to form a latch tail groove 243; and the top cover 23 includes at least one first transverse flip plate 231 formed at the inner periphery proximate to the bottom of the top cover 23 and configured corresponsive to the square slot 222 and at least one second transverse flip plate 232 configured to be corresponsive to the L-shaped notch 24; and when the top cover 23 is covered onto the outer sleeve 22, the first transverse flip plate 231 of the top cover 23 pushes a wall of the outer sleeve 22 to move and press into the square slot 222, while the second transverse flip plate 232 of the top cover 23 is installed downwardly into the longitudinal groove 241 of the L-shaped notch 24 along the outer sleeve 22 and then moved transversely along the transverse chute 242. If there is no external force, the outer sleeve 22 remains in the latch tail groove 243, so that the top cover 23 and the outer sleeve 22 are coupled securely with each other.

In summation of the description above, the present invention complies with the patent application requirements, and thus is duly filed for patent application. While the invention has been described by means of specific embodiments, numerous modifications and variations could be made thereto by those skilled in the art without departing from the scope and spirit of the invention set forth in the claims.

What is claimed is:

1. A coupling structure of a lampholder housing, comprising an outer sleeve and a top cover, characterized in that the outer sleeve includes at least one square slot and at least one L-shaped notch formed on an outer wall proximate to the top edge of the outer sleeve and the L-shaped notch has a longitudinal groove penetrating from the top edge downwardly deep into a distance and then turning at a right angle to form a transverse chute, and an end of the longitudinal groove is extended upward to form a latch tail groove; the top cover includes at least one first transverse flip plate disposed at an inner periphery proximate to the bottom of the top cover and configured to be corresponsive to the square slot and at least one second transverse flip plate configured to be corresponsive to the L-shaped notch; and when the top cover is covered onto the outer sleeve, the first transverse flip plate of the top cover pushes a wall of the outer sleeve to press into the square slot, while the second transverse flip plate of the top cover is being installed downwardly into the longitudinal groove along the L-shaped notch of the outer sleeve and then moved transversely moved along the transverse chute, and remaining in the latch tail groove provided that no external force is exerted, so that the top cover and the outer sleeve are coupled securely with each other.
